(19) United States
(12) Patent Application Publication
(10) Pub. No.: US 2015/0271119 A1
(43) Pub. Date: Sep. 24, 2015

(54) Message Classification System with Context Determination and Method of Operation Thereof

(71) Applicant: Motorola Mobility LLC, Chicago, IL (US)

(72) Inventor: Alex G. Goncalves, Sunnyvale, CA (US)

(73) Assignee: Motorola Mobility LLC, Chicago, IL (US)

(21) Appl. No.: 14/219,048

(22) Filed: Mar. 19, 2014

(51) Int. Cl. H04L 12/58

(52) U.S. Cl. CPC H04L 51/16

(57) ABSTRACT

A message classification system and method of manufacture operation thereof including: a receiving device including: a communication unit for receiving a threaded message, the threaded message part of a message thread having multiple messages, a processing unit coupled to the communication unit for: generating an emotional content identifier based on the threaded message, the emotional content identifier having a confidence value, and determining a master emoticon based on the confidence value of the emotional content identifier of the threaded message and at least one of the multiple messages for display on a display interface.

### TECHNICAL FIELD

The present invention relates generally to a message classification system, and more particularly to a system for determining the context of a message or messages.

### BACKGROUND ART

Modern portable consumer and industrial electronics, especially devices such as navigation systems, smartphones, portable digital assistants, and other mobile devices, are providing increasing levels of functionality to support modern life including personalized information services. Research and development in the existing technologies can take a myriad of different directions.

As users become used to mobile devices and easy access to personalized services, expectations for personalization rise. There are many technological solutions to take advantage of the vast amount of data generated and received by each person in the course of their daily lives. One approach is to use personal profiles and personalized data of a user to deliver customized productivity tools, content, and advertising to the user on their mobile device, such as a smartphone. Another approach is to sort received messages according to user-determined categories. However, none of these solutions solve the problem of managing the time it takes to read the messages themselves.

Thus, a need still remains for an efficient method for quickly determining the content of a message. In view of the proliferation of communication on mobile devices, it is increasingly critical that answers be found to these problems. In view of the ever-increasing commercial competitive pressures, along with growing consumer expectations and the diminishing opportunities for meaningful product differentiation in the marketplace, it is crucial that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a message classification system including: receiving a threaded message, the threaded message part of a message thread having multiple messages; generating an emotional content identifier based on the threaded message, the emotional content identifier having a confidence value; and determining a master emoticon based on the confidence value of the emotional content identifier of the threaded message and at least one of the multiple messages for display on a display interface.

The present invention provides a message classification system, including: a receiving device including: a communication unit for receiving a threaded message, the threaded message part of a message thread having multiple messages, a processing unit coupled to the communication unit for: generating an emotional content identifier based on the threaded message, the emotional content identifier having a confidence value, and determining a master emoticon based on the confidence value of the emotional content identifier of the threaded message and at least one of the multiple messages for display on a display interface.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a message classification system in an embodiment of the present invention.

FIG. 2 is an example of the display interface of the receiving device of the message classification system.

FIG. 3 is a flow chart of a method of operation of a message classification system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals.

For expository purposes, the term “horizontal” as used herein is defined as a plane parallel to the plane or line which makes text on a screen readable, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures.

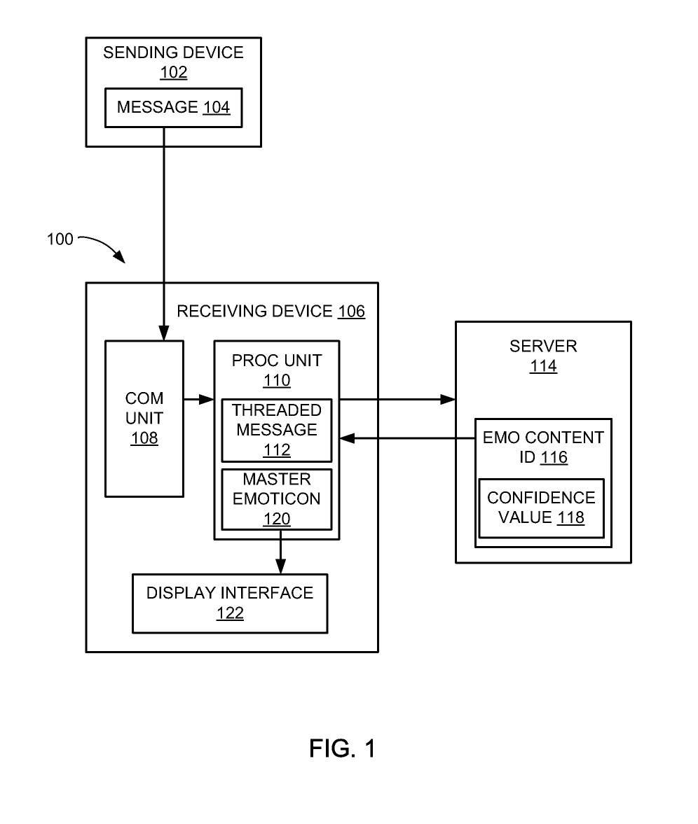

Referring now to FIG. 1, therein is shown a message classification system 100 in an embodiment of the present invention. The message classification system 100 is shown with a sending device 102 sending a message 104 to a receiving device 106. The receiving device 106 can be a smartphone, feature phone, smartwatch, tablet, “phablet,” or other mobile device, for example.

The receiving device 106 can include a communication unit 108 for receiving the message 104 from the sending device 102. The communication unit 108 can be connected to a processing unit 110, which can determine whether the message 104 is a standalone message or a threaded message 112 (part of a message thread, for example) using a threading module, for example. The threaded message 112 is defined as a message which is part of a series of messages connected through common topics, subjects, headers, participants, other attributes of the messages, or a combination thereof. For example, a threaded set of emails can be determined by common subject lines or by examining the quoted content. Also for example, a threaded text message conversation can be determined by checking for the same participants in the conversation.

If the message 104 is determined to be the threaded message 112, the processing unit 110 can pass the threaded message 112 to a server 114. For illustrative purposes, the message 104 is shown as sent directly from the sending device 102 to the receiving device 106, but it is understood that other sending/receiving options exist. For example, the sending device 102 could send the message 104 to the server 114 for a determination of whether the message 104 is the threaded message 112 or a standalone message.

An emotional content module within the server 114 or the receiving device 106 can determine the emotional context or tone of the threaded message 112 and can generate an emotional content identifier 116 and a confidence value 118 associated with the emotional content identifier 116 for the threaded message 112. The emotional content identifier 116 is a determination of the overall emotional tone of the threaded message 112. For example, the emotional content identifier 116 can identify the threaded message 112 as having an emotional tone that is happy, sad, angry, or other emotion. The confidence value 118 of the emotional content identifier 116 can be a numerical value (from 1-100, for example) of the level of confidence that the emotional content identifier 116 has been determined correctly. For example, if the confidence value 118 is 20, the emotional tone of the threaded message 112 can have been determined to be a particular emotion, but without a high degree of confidence. Also for example, if the confidence value is 80, the emotional tone of the threaded message 112 can have been determined to a high level of confidence. The confidence value 118 of the emotional content identifier 116 can be dependent on many factors such as the length of the message, the content of prior messages, use of punctuation, past patterns of interaction of participants, other contextual factors, or a combination thereof, for example.

For illustrative purposes, the emotional content identifier 116 and the confidence value 118 are shown as determined on the server 114, but it is understood that other processing options are available. For example, one alternative, given enough processing power within the processing unit 110 of the receiving device 106, is for the emotional content module to operate entirely within the processing unit 110 without any determination of emotional tone by the server 114.

Once the emotional content identifier 116 and the confidence value 118 are received, generated, or determined by the receiving device 106, the processing unit 110 can operate an emoticon generation module, coupled to the emotional content module, to generate a graphical representation of the emotional tone of the threaded message 112 (sometimes called an “emoticon”), for example. The emoticon generation module can also generate a master emoticon 120 which can represent the overall emotional content of the threaded messages or conversation. The master emoticon 120 can then be displayed on a display interface 122 of the receiving device 106.

The master emoticon 120 can be determined or generated based on the confidence value 118 of all instances of the threaded message 112 in the threaded conversation or email. For example, the master emoticon 120 can determined based on the emotional content of the threaded message 112 having the confidence value 118 at the highest level relative to the last 10 messages. Also for example, the master emoticon 120 can be determined based on aggregating the confidence value 118 of all of the messages in the message thread or email chain, and choosing the master emoticon 120 based on the emotional tone associated with the confidence value 118 having the highest aggregated score. Other factors can be taken into account to determine the master emoticon 120 such as time between messages, weighting message importance, speed of emotional content change, temporal separation of replies, higher weight for more recent messages, or a combination thereof, for example. Specific implementations of the master emoticon 120 can be tailored to the intended audience with regards to the design of the various emoticons, and there is no limitation on how emotions may be represented.

It has been discovered that the master emoticon 120 generated for entire threaded conversation or threaded email chain improves the user experience and usability of text-based communication. Users are inundated with such amounts of information on a daily basis that incoming messages can quickly become overwhelming. The master emoticon 120 or an emoticon for the message 104 can allow the user to quickly ascertain the emotional content of a message or the general tone of a conversation. For example, the user can determine at a glance that a conversation has taken a bad turn if the master emoticon 120 indicates an increasing level of anger, and an evaluation can be made as to how quickly to respond to the message. Also for example, if the master emoticon 120 indicates a calm exchange of messages, the user can decide whether to put off answering messages until later or not. The master emoticon 120 or emoticons for each individual message allow a user to quickly and intuitively prioritize incoming messages, for example.

For illustrative purposes, the emotional content identifier 116, the confidence value 118, and the master emoticon 120 are described as based on threaded messages or conversations, but it is understood that other possibilities exist. For example, a standalone message can also have the emotional content identifier 116 and the confidence value 118 determined. In this example, the master emoticon 120 can be the same as the emoticon generated for the standalone message.

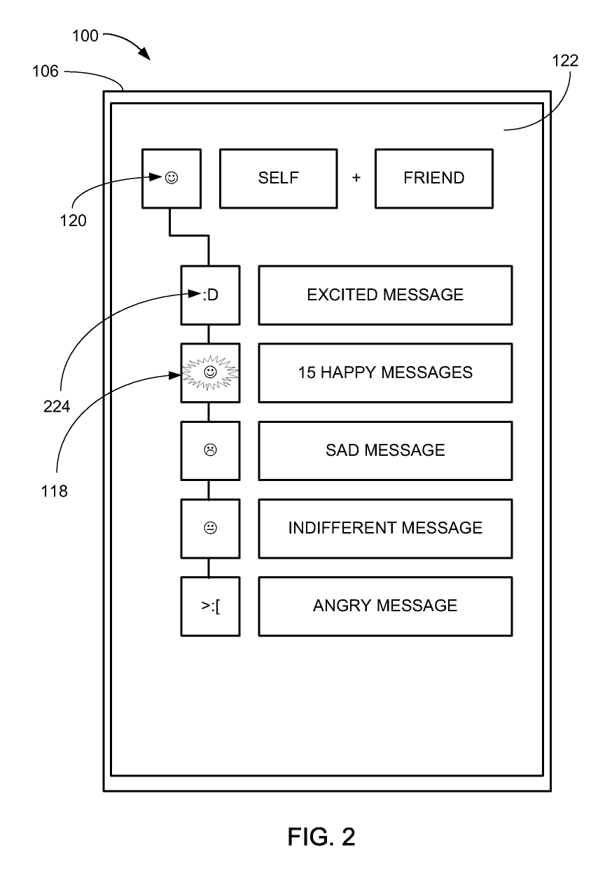

Referring now to FIG. 2, therein is shown an example of the display interface 122 of the receiving device 106 of the message classification system 100. In this example, a text message conversation is shown. The master emoticon 120 marking the conversation can be seen, along with various examples of individual message emoticons 224.

If a user sees the master emoticon 120 and decides to view the threaded conversation or messages, the thread can be expanded such that the individual message emoticons 224 are visible. The confidence value 118 associated with each of the individual message emoticons 224 may be shown to the user in various ways other than by showing a numerical value. The confidence value 118 for each of the individual message emoticons 224 can be calculated in a similar manner to that of the confidence value 118 associated with the emotional content identifier 116 of FIG. 1 of the threaded message 112 of FIG. 1. In this example, the most recent message can be seen to have one of the individual message emoticons 224 indicating an excited message. The immediately prior message is shown with one of the individual message emoticons 224 indicating a happy message, with a much higher score for the confidence value 118 indicated by a graphical effect around this example of one of the individual message emoticons 224. In this example, the high score of the confidence value 118 is shown by a glowing effect. Other possibilities exist to show the relative scores of the confidence value 118 of each of the individual message emoticons 224 such as different colors, size of the emoticons, intensity of the emoticons, relative opacity, other graphical effects, or a combination thereof. The high level of the confidence score 118 for the message marked as a happy message can be weighted highly when determining the master emoticon 120, causing the message thread to be marked with an overall emotional tone of happy, for example.

The user can select individual messages to view in greater detail, depending on how the user has chosen to view the message thread. For example, the message thread can display only the first few words of each message along with the individual message emoticons 224 in order to increase information density. In such an example, the user can select individual messages or a subset of messages to view in greater detail. For example, the user can select all of the happy messages, or all the angry messages to view in greater detail.

Additionally, the message classification system 100 can group messages with the same emotional content or tone for greater information density. For example, an unbroken series of happy messages can all be grouped under the same one of the individual message emoticons 224 indicating happy messages. A number of messages within a group can also show up to give the user additional information, for example.

It has been discovered that the confidence value 118 being indicated with graphical effects around or directly modifying the individual message emoticons 224 improves usability and allows a user to quickly filter messages, emails, or other textual communications. The confidence value 118 can allow a user to quickly prioritize messages and evaluate whether, for example, an angry message with the confidence value 118 at a low value (for example, if the emoticon is shown as largely transparent) is worth worrying about in the near-term. To extend the example, if a set of happy messages have the confidence value 118 at a high level, the user can decide to wait to answer the last message that came in since an urgent response is likely unnecessary. Ultimately, the individual message emoticons 224 combined with the confidence value 118 can allow a user to quickly decide whether to respond to a just-received message right away or to wait.

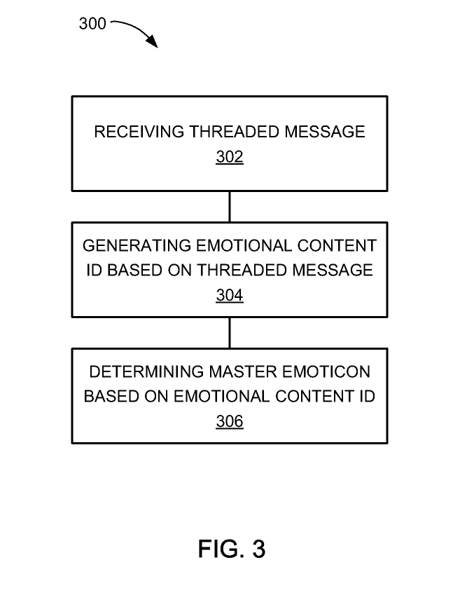

Referring now to FIG. 3, therein is shown a flow chart of a method 300 of operation of a message classification system in a further embodiment of the present invention. The method 300 includes: receiving a threaded message, the threaded message part of a message thread having multiple messages in a block 302; generating an emotional content identifier based on the threaded message, the emotional content identifier having a confidence value in a block 304; and determining a master emoticon based on the confidence value of the emotional content identifier of the threaded message and at least one of the multiple messages for display on a display interface in a block 306.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a message classification system comprising:
receiving a threaded message, the threaded message part of a message thread having multiple messages;
generating an emotional content identifier based on the threaded message, the emotional content identifier having a confidence value; and
determining a master emoticon based on the confidence value of the emotional content identifier of the threaded message and at least one of the multiple messages for display on a display interface.

2. The method as claimed in claim 1 further comprising:
selecting the master emoticon for viewing the multiple messages.

3. The method as claimed in claim 1 further comprising:
receiving a message; and
determining the message to be the threaded message which is part of the message thread based on common participants.

4. The method as claimed in claim 1 wherein the emotional content identifier identifies the emotional tone of the threaded message.

5. The method as claimed in claim 1 wherein receiving the threaded message includes receiving the threaded message on a receiving device.

6. A method of operation of a message classification system comprising:
receiving a message;
determining the message to be a threaded message which is part of a message thread based on common participants, the message thread having multiple messages;
generating an emotional content identifier based on the threaded message, the emotional content identifier having a confidence value;
determining a master emoticon based on the confidence value of the emotional content identifier of the threaded message and at least one of the multiple messages for display on a display interface; and
selecting the master emoticon for viewing the multiple messages on the display interface.

7. The method as claimed in claim 6 wherein selecting the master emoticon for viewing the multiple messages includes displaying individual message emoticons for the multiple messages.

8. The method as claimed in claim 6 further comprising selecting one of the multiple messages for display on the display interface.

9. The method as claimed in claim 6 wherein selecting the master emoticon for viewing the multiple messages includes:
displaying individual message emoticons for the multiple messages; and
displaying the confidence value of each of the individual message emoticons.

10. The method as claimed in claim 6 further comprising selecting one of the multiple messages.

11. A message classification system comprising:
a receiving device including:
a communication unit for receiving a threaded message, the threaded message part of a message thread having multiple messages,
a processing unit coupled to the communication unit including:
an emotional content module for generating an emotional content identifier based on the threaded message, the emotional content identifier having a confidence value, and
an emoticon generation module, coupled to the emotional content module, for determining a master emoticon based on the confidence value of the emotional content identifier of the threaded message and at least one of the multiple messages for display on a display interface.

12. The system as claimed in claim 11 wherein the display interface is for selecting the master emoticon for viewing the multiple messages.

13. The system as claimed in claim 11 wherein:
the communication unit is for receiving a message; and
the processing unit includes a threading module for determining the message to be the threaded message which is part of the message thread based on common participants.

14. The system as claimed in claim 11 wherein the emotional content identifier identifies the emotional tone of the threaded message

15. The system as claimed in claim 11 further comprising a server for generating the emotional content identifier based on the threaded message, the emotional content identifier having the confidence value.

16. The system as claimed in claim 11 further comprising:
a server for generating the emotional content identifier based on the threaded message, the emotional content identifier having the confidence value; and
wherein:
the display interface is for selecting the master emoticon for viewing the multiple messages; and

17. The system as claimed in claim 16 wherein the display interface is for displaying individual message emoticons for the multiple messages.

18. The system as claimed in claim 16 wherein the display interface is for selecting one of the multiple messages for display on the display interface.

19. The system as claimed in claim 16 wherein the display interface is for:
displaying individual message emoticons for the multiple messages; and
displaying the confidence value of each of the individual message emoticons.

20. The system as claimed in claim 16 wherein the display interface is for selecting one of the multiple messages.
